(19) United States
(12) Patent Application Publication
(10) Pub. No.: US 2009/0050614 A1
(43) Pub. Date: Feb. 26, 2009

(54) VEHICLE SIDE WINDOW HEATING SYSTEMS

(75) Inventors: DAVID T. RENKE, MACOMB, MI (US); JERRY MALLARD, WATERFORD, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 11/844,820

(22) Filed: Aug. 24, 2007

(51) Int. Cl. B60L 1/02

(52) U.S. Cl. 219/203

(57) ABSTRACT

In accordance with an exemplary embodiment of the present invention, a heating system for a side window of a vehicle is provided. The heating system comprises a belt seal and a resistive element. The belt seal is configured to be installed on the vehicle at a location at least partially surrounding the side window. The resistive element is embedded within the belt seal. The resistive element is configured to receive power from a power source and to heat the side window.

### TECHNICAL FIELD

The present invention generally relates to the field of vehicles and, more specifically, to side window heating systems for vehicles.

### BACKGROUND OF THE INVENTION

Today's vehicles include a number of features to enhance the driving experience in cold weather. For example, today's vehicles typically include a front window defrost system to prevent the freezing of and improve the visibility through the front window. However, it is possible for side windows of vehicles to become frozen in cold weather. When this occurs, it may be more difficult to open and close the side windows, for example when approaching a drive through bank or food establishment. This may also make it more difficult to see through the side window.

Accordingly, it is desired to provide a side window heating system for heating a side window of a vehicle. Furthermore, other desirable features and characteristics of the present invention will be apparent from the subsequent detailed description and the appended claims, taken in conjunction with the accompanying drawings and the foregoing technical field and background.

### SUMMARY OF THE INVENTION

In accordance with an exemplary embodiment of the present invention, a heating system for a side window of a vehicle is provided. The heating system comprises a belt seal and a resistive element. The belt seal is configured to be installed on the vehicle at a location at least partially surrounding the side window. The resistive element is embedded within the belt seal. The resistive element is configured to receive power from a power source and to heat the side window.

In accordance with another exemplary embodiment of the present invention, a heating system for a side window of a vehicle is provided. The heating system comprises a resistive element and a connector. The resistive element is configured to be embedded within a sealing element proximate the side window, and is configured to heat the side window. The connector is configured to couple the resistive element to a power source, and to deliver power from the power source to the resistive element.

In accordance with a further exemplary embodiment of the present invention, a heating system for a side window of a vehicle is provided. The heating system comprises a belt seal, a resistive element, and a connector. The belt seal is configured to be installed on the vehicle at a location at least partially surrounding the side window. The resistive element is embedded within the belt seal, and is configured to heat the side window. The connector is configured to couple the resistive element to a power source, and to deliver power from the power source to the resistive element.

### DESCRIPTION OF THE DRAWINGS

The present invention will hereinafter be described in conjunction with the following drawing figures, wherein like numerals denote like elements, and wherein:

FIG. 1 is a side view of a portion of a vehicle with a side window heating system in accordance with an exemplary embodiment of the present invention;

FIG. 2 is a functional block diagram of a side window heating system for a vehicle, such as the vehicle of FIG. 1, in accordance with an exemplary embodiment of the present invention; and

FIG. 3 is an exploded view of a portion of a connector that can be use in connection with the side window heating system of FIG. 2 in accordance with an exemplary embodiment of the present invention.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

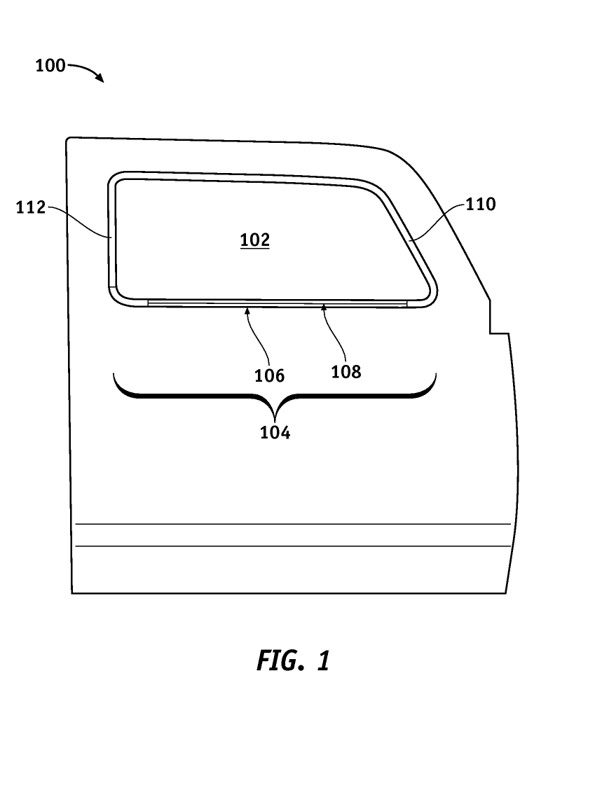

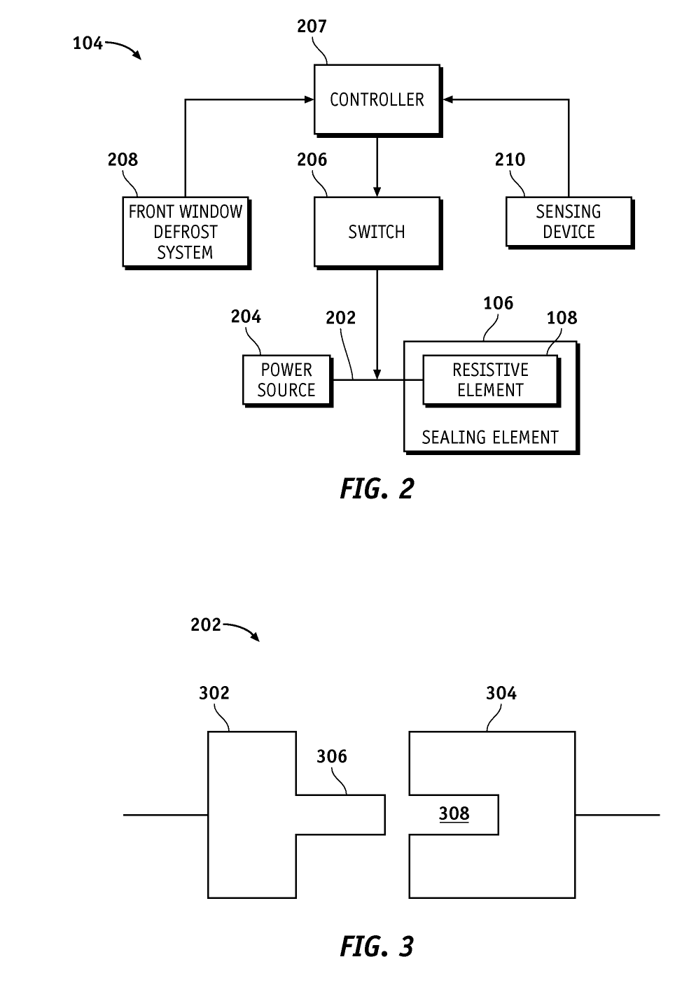

FIG. 1 is a side view of a portion of a vehicle 100 in accordance with an exemplary embodiment of the present invention. As depicted in FIG. 1, the vehicle 100 includes a side window 102 and a side window heating system 104. As described in greater detail further below in connection with FIG. 2, the side window heating system 104 includes a sealing element 106 and a resistive element 108 embedded therein. In the exemplary embodiment of FIG. 1, the sealing element 106 is an outer belt seal surrounding the side window 102, and the resistive element 108 is a wire embedded therein. However, this may vary in other embodiments. For example, in other embodiments the sealing element 106 may include a side rail 110 or an inner belt seal 112 (shown in phantom in FIG. 1) with a wire or other resistive element 108 embedded therein.

The side window 102 may be disposed on a front or rear portion of, and on a driver's or passenger's side of, the vehicle 100. In various embodiments, side window heating systems 104 may be disposed proximate multiple side windows 102 of the vehicle 100, for example a front driver's side window, a rear driver's side window, a front passenger's side window, and/or a rear passenger's side window.

Turning now to FIG. 2, a functional block diagram of the side window heating system 104 is depicted in accordance with an exemplary embodiment of the present invention. As depicted in FIG. 2, the side window heating system 104 includes the above-mentioned sealing element 106 and resistive element 108 as well as a connector 202, a switch 206, a controller 207, and a sensing device 210. As discussed above, the sealing element 106 comprises an outer belt seal in an exemplary embodiment, but may also comprise an inner belt seal, a side rail, and/or another embedding device. Regardless of its type, the sealing element 106 is configured to be installed on the vehicle at a location at least partially surrounding the side window.

Also as discussed above, the resistive element 108 comprises a wire in an exemplary embodiment. However, the resistive element 108 may also comprise other materials having resistive properties, such as a conductive plastic or carbon composite material. Regardless of its type, the resistive element 108 is embedded within the sealing element 106 and is configured to heat the side window 102, thereby allowing improved access to and/or improved visibility through the side window 102. Also, in certain embodiments the sealing element 106, such as a belt seal, may comprise the resistive element 108 in whole or in part.

The connector 202 couples the resistive element 108 to a power source 204, and delivers power from the power source 204 to the resistive element 108, which then heats the side window 102. The connector 202 is made of a conductive material and creates an electrical circuit between the power source 204 and the resistive element 108. In one exemplary embodiment depicted in FIG. 3, the connector 202 includes one or more plugs 302 and sockets 304, for example at a point of connection to the resistive element 108. Each plug 302 includes one or more prongs 306 that are inserted into one or more mating openings 308 in a respective socket 304. Also in an exemplary embodiment, the power source 204 is a vehicle electrical power system, such as a vehicle battery and/or alternator. However, the connector 202 and the power source 204 may vary in other embodiments.

Returning now to FIG. 2, the switch 206 is coupled to the connector 202 and/or is formed as part of the connector 202. The switch 206 is movable between a first position and a second position. When in the first position, the switch 206 allows the connector 202 to deliver power from the power source 204 to the resistive element 108. When in the second position, the switch 206 at least substantially prevents the connector 202 from delivering power from the power source 204 to the resistive element 108.

The controller 207 is coupled to the switch 206, and is configured to move the switch 206 between the first and second positions. In the exemplary embodiment of FIG. 2, the controller 207 is also coupled to a front window defrost system 208 and the above-mentioned sensing device 210. The controller 207 is configured to move the switch 206 to the first position when either the front window defrost system 208 begins operating or when the sensing device 210 senses that an operator of the vehicle 100 desires side window 102 heating. Preferably, the controller 207 thereafter moves the switch 206 back to the second position after a predetermined amount of time. In certain embodiments, the side window heating system 104 may be automatically activated in this manner each time the front window defrost system 208 is turned on. In other embodiments the side window heating system 104 may be automatically activated in this manner only during the first time that the front window defrost system 208 is activated during a particular driving event.

The sensing device 210 determines whether the operator of the vehicle 100 desires the side window 102 to be heated separately from the front window defrost system 208. For example, such separate heating of the side window 102 may be desired in situations in which a front window of the vehicle has already been adequately defrosted by the front window defrost system 208 but the side window 102 requires additional heating. Specifically, the sensing device 210 receives input from the operator of the vehicle 100 when such separate side window 102 heating is desired by the operator. For example, the operator may press a button when side window 102 heating is desired. The sensing device 210 is thereby activated at least indirectly by the operator of the vehicle 100.

Once the sensing device 210 is activated, an indication thereof is provided to the controller 207, which then moves the switch 206 to the first position as described above. The controller 207 then moves the switch 206 back to the second position after a predetermined amount of time, also as described above. Thus, in an exemplary embodiment, the side window heating system 104 heats the side window 102 for a predetermined amount of time following either or both of the activation of the front window defrost system 208 of the vehicle 100 and/or the activation of the sensing device 210 by the operator of the vehicle 100 desiring separate side window 102 heating.

It will be appreciated that in different embodiments the side window heating system 104 may include a different combination of the components set forth in FIG. 2, while other components may already exist separately in the vehicle 100. For example, in another exemplary embodiment, the side window heating system 104 may comprise a sealing element 106, a resistive element 108, a connector 202, and the sensing device 210, while the controller 207 and/or the switch 206 may already exist separately in the vehicle 100. In a further exemplary embodiment, the side window heating system 104 may comprise a sealing element 106 and a resistive element 108, while the connector 202 (in addition to the sensing device 210, the controller 207, and/or the switch 206) may already exist separately in the vehicle 100. In yet another exemplary embodiment, the power source 204 and/or the front window defrost system 208 may be part of the side window heating system 104 instead of existing separately in the vehicle 100.

In certain embodiments, the side window heating system 104 need not be used in connection with any front window defrost system 208. Similarly, it will be appreciated that the side window heating system 104 may include two or more of the various components depicted in FIG. 2, such as two or more sealing elements 106, two or more resistive elements 108, two or more connectors 202, two or more power sources 204, two or more switches 206, two or more controllers 207, and/or two or more sensing devices 210. Such multiple components may be necessary, for example, if the side window heating system 104 is configured to heat multiple side windows 102 of the vehicle 100.

Having described an exemplary embodiment of the side window heating system 104, the operation of an exemplary embodiment of the side window heating system 104 will now be described. For discussion purposes, the switch 206 is assumed to begin in the second position, in which the connector 202 does not allow the resistive element 108 to receive power from the power source 204. The controller 207 moves the switch 206 to the first position upon either of the following two events: (i) the front window defrost system 208 is activated, or (ii) the sensing device 210 is activated by a vehicle operator desiring side window 102 washing. Once the controller 207 moves the switch 206 to the first position, the switch 206 allows the connector 202 to deliver power from the power source 204 to the resistive element 108. The resistive element 108 then heats at least a portion of the side window 102. After a predetermined amount of time has subsequently elapsed, the controller 207 moves the switch 206 back to the second position, and the connector 202 is once again prevented from delivering power from the power source 204 to the resistive element 108. The sealing element 106 holds the resistive element 108 against the side window 102 during the entire time.

Accordingly, a side window heating system 104 has been disclosed. The side window heating system 104 provides for effective heating of one or more side windows 102 of a vehicle 100, and thereby allows for improved control of, access for, and visibility through the side windows 102. It will be appreciated that the side window heating system 104 may be implemented in connection with various different types of vehicles.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A heating system for a side window of a vehicle, the heating system comprising:
a belt seal configured to be installed on the vehicle at a location at least partially surrounding the side window; and
a resistive element embedded within the belt seal and configured to receive power from a power source and to heat the window.

2. The heating system of claim 1, wherein the resistive element comprises a wire element.

3. The heating system of claim 1, wherein the belt seal comprises a resistive element.

4. The heating system of claim 1, wherein the power source comprises a vehicle electrical system of the vehicle.

5. The heating system of claim 1, further comprising:
a connector configured to couple the resistive element to the power source and to deliver power from the power source to the resistive element; and
a switch coupled to the connector, the switch movable between a first position, in which the switch allows the connector to deliver power from the power source to the resistive element, and a second position, in which the switch at least substantially prevents the connector from delivering power from the power source to the resistive element.

6. The heating system of claim 5, further comprising:
a controller coupled to the switch and configured to be coupled to a front window defrost system of the vehicle, wherein the controller is configured to move the switch:
to the first position when the front window defrost system begins operating; and
to the second position after the front window defrost system has been operating for a predetermined amount of time.

7. The heating system of claim 6, further comprising:
a sensing device coupled to the controller and configured to receive input from and to thereby be activated at least indirectly by an operator of the vehicle when side window heating is desired by the operator of the vehicle;
wherein the controller is configured to move the switch to the first position when the sensing device has been activated.

8. A heating system for a side window of a vehicle, the heating system comprising:
a resistive element configured to be embedded within a sealing element proximate the side window, the resistive element configured to heat the side window; and
a connector configured to couple the resistive element to a power source, and to deliver power from the power source to the resistive element.

9. The heating system of claim 8, wherein the resistive element is configured to be embedded within a belt seal at least partially surrounding the side window.

10. The heating system of claim 8, wherein the resistive element comprises a wire element.

11. The heating system of claim 8, wherein the power source comprises a vehicle electrical system of the vehicle.

12. The heating system of claim 8, further comprising:
a switch coupled to the connector, the switch movable between a first position, in which the switch allows the connector to deliver power from the power source to the resistive element, and a second position, in which the switch at least substantially prevents the connector from delivering power from the power source to the resistive element.

13. The heating system of claim 12, further comprising:
a controller coupled to the switch and configured to be coupled to a front window defrost system of the vehicle, wherein the controller is configured to move the switch:
to the first position when the front window defrost system begins operating; and
to the second position after the front window defrost system has been operating for a predetermined amount of time.

14. The heating system of claim 13, further comprising:
a sensing device coupled to the controller and configured to receive input from and to thereby be activated at least indirectly by an operator of the vehicle when side window heating is desired by the operator of the vehicle;
wherein the controller is configured to move the switch to the first position when the sensing device has been activated.

15. A heating system for a side window of a vehicle, the heating system comprising:
a belt seal configured to be installed on the vehicle at a location at least partially surrounding the side window;
a resistive element embedded within the belt seal and configured to heat the side window; and
a connector configured to couple the resistive element to a power source, wherein the connector is configured to deliver power from the power source to the resistive element.

16. The heating system of claim 15, further comprising:
a switch coupled to the connector, the switch movable between a first position, in which the switch allows the connector to deliver power from the power source to the resistive element, and a second position, in which the switch at least substantially prevents the connector from delivering power from the power source to the resistive element; and.

17. The heating system of claim 16, further comprising:
a controller coupled to the switch and configured to be coupled to a front window defrost system of the vehicle, wherein the controller is configured to move the switch:
to the first position when the front window defrost system begins operating; and
to the second position after the front window defrost system has been operating for a predetermined amount of time.

18. The heating system of claim 17, further comprising:
a sensing device coupled to the controller and configured to receive input from and to thereby be activated at least indirectly by an operator of the vehicle when side window heating is desired by the operator of the vehicle;
wherein the controller is configured to move the switch to the first position when the sensing device has been activated.

19. The heating system of claim 15, wherein the resistive element comprises a wire element.

20. The heating system of claim 15, wherein the belt seal comprises a resistive element.
